(19) United States
(12) Patent Application Publication
(10) Pub. No.: US 2024/0126796 A1
(43) Pub. Date: Apr. 18, 2024

(54) SYSTEMS AND METHODS FOR EXTRACTING INFORMATION FROM SERVICE SUMMARIES

(71) Applicant: BrainX, LLC, Broadview Heights, OH (US)

(72) Inventors: Piyush MATHUR, Broadview Heights, OH (US); Francis A. PAPAY, Westlake, OH (US); Kamal MAHESHWARI, Solon, OH (US); Ashish K. KHANNA, Winston-Salem, NC (US); Jacek B. CYWINSKI, Broadview Heights, OH (US); Raghav AWASTHI, Narwal (IN); Shreya MISHRA, Haridwar (IN)

(21) Appl. No.: 18/486,794

(22) Filed: Oct. 13, 2023

Related U.S. Application Data
(60) Provisional application No. 63/379,761, filed on Oct. 16, 2022.
(60) Provisional application No. 63/379,760, filed on Oct. 16, 2022.

(51) Int. Cl. G06F 16/332; G06F 16/34; G06F 16/35

(52) U.S. Cl. CPC G06F 16/3329; G06F 16/345; G06F 16/353

(57) ABSTRACT

Systems and methods for automatically answering questions based on a biomedical document are presented herein. The system may include a question-answering machine learning model. The question-answering machine learning model may be enhanced by segmenting the document. The system may include a topic clustering machine learning model for segmenting the document. Through segmentation, the resulting system may provide a lower error rate at a lower computational cost when compared to traditional question-answering machine learning models.

### CROSS-REFERENCE TO RELATED APPLICATIONS

This application claims priority to U.S. Provisional Patent Application 63/379,760, titled “AUTOMATED PREAUTHORIZATION USING BLOCKCHAIN,” filed on Oct. 16, 2022, and U.S. Provisional Patent Application 63/379,761, titled “SYSTEMS AND METHODS FOR EXTRACTING INFORMATION FROM SERVICE SUMMARIES,” filed on Oct. 16, 2022, each of which is hereby incorporated by reference herein in their entirety.

### SUMMARY

In some aspects, the techniques described herein relate to a method of extracting information from a summary of service, the method including: receiving a summary of service and a query related to the summary of service; segmenting the summary of service into one or more data categories to create a structured summary of service; determining a targeted segment of the structured summary of service based on the query; and determining an answer to the query using a question-answering machine learning model and the targeted segment.

In some aspects, the techniques described herein relate to a method, further including: receiving service data; and training the question-answering machine learning model using the service data.

In some aspects, the techniques described herein relate to a method, wherein segmenting the summary of service into one or more data categories includes: generating the structured summary of service using a topic-clustering machine learning model.

In some aspects, the techniques described herein relate to a method, wherein segmenting the summary of service into one or more data categories further includes: receiving one or more summaries of service; transforming the one or more summaries services into a training set using contextual information; and training the topic-clustering machine learning model using the training set.

In some aspects, the techniques described herein relate to a method, wherein the topic-clustering machine learning model is a natural language processor.

In some aspects, the techniques described herein relate to a method, wherein the topic-clustering machine learning model is a Doc2Vec model.

In some aspects, the techniques described herein relate to a method, wherein the question-answering machine learning model is a natural language processor.

In some aspects, the techniques described herein relate to a method, wherein the question-answering machine learning model is a Bidirectional Encoder Representations from Transformers (BERT)model.

In some aspects, the techniques described herein relate to a method, wherein the service includes at least one of: a medical diagnosis, a car repair estimate, a home repair estimate, or a life insurance summary.

In some aspects, the techniques described herein relate to a method, wherein the targeted segment includes at least one of patient information, history, physical examination, home medicine, pertinent results, management, and discharge planning.

In some aspects, the techniques described herein relate to a method, wherein determining a targeted segment of the structured summary of service based on the query includes comparing a topic of each segment in the structured summary of service with a topic associated with the query.

In some aspects, the techniques described herein relate to a method, further including generating the topic associated with the query by using a topic-clustering machine learning model on the query.

In some aspects, the techniques described herein relate to a system for extracting information from a summary of service, the system including: one or more processors; and one or more non-transitory, processor-readable storage medium, wherein the one or more non-transitory, processor-readable storage medium includes one or more programming instructions that, when executed, cause the one or more processors to: receive service data; train a question-answering machine learning model using the service data; receive a summary of service and a query related to the summary of service; segment the summary of service into one or more data categories to create a structured summary of service; determine a targeted segment of the structured summary of service based on the query; and determine an answer to the query using the question-answering machine learning model and the targeted segment.

In some aspects, the techniques described herein relate to a system, wherein the one or more programming instructions that, when executed, cause the one or more processors to segment the summary of service into one or more data categories further includes one or more programming instructions that, when executed, cause the one or more processors to: receive one or more summaries of service; transform the one or more summaries of services into a training set using contextual information; train a topic-clustering machine learning model using the training set; and generate the structured summary of service using the topic-clustering machine learning model.

In some aspects, the techniques described herein relate to a system, wherein the topic-clustering machine learning model is a natural language processor.

In some aspects, the techniques described herein relate to a system, wherein the question-answering machine learning model is a natural language processor.

In some aspects, the techniques described herein relate to a system, wherein the service includes at least one of: a medical diagnosis, a car repair estimate, a home repair estimate, or a life insurance summary.

In some aspects, the techniques described herein relate to a system, wherein the targeted segment includes at least one of patient information, history, physical examination, home medicine, pertinent results, management, and discharge planning.

In some aspects, the techniques described herein relate to a system, wherein the one or more programming instructions that, when executed, cause the one or more processors to determine a targeted segment of the structured summary of service based on the query further includes one or more programming instructions that, when executed, cause the one or more processors to: compare a topic of each segment in the structured summary of service with a topic associated with the query.

In some aspects, the techniques described herein relate to a system, further including one or more programming instructions that, when executed, cause the one or more processors to: generate the topic associated with the query by using a topic-clustering machine learning model on the query.

### BRIEF DESCRIPTION OF THE DRAWINGS

Aspects and embodiments of this application are depicted in the figures, wherein:

FIG. 1 depicts an illustrative block diagram of a prior art implementation of a question-answering machine learning model.

FIG. 2 depicts an illustrative block diagram of an implementation of a question-answering machine learning model in accordance with an embodiment.

FIG. 3 depicts an illustrative flow diagram of a method for answering questions based on a summary of service in accordance with an embodiment.

FIG. 4 depicts an illustrative flow diagram of a method for determining a segment of a summary of service in accordance with an embodiment.

FIG. 5 depicts a block diagram of an illustrative data processing system comprising internal hardware that may be used to contain or implement various computer processes and systems.

### DETAILED DESCRIPTION OF EMBODIMENTS

This disclosure is not limited to the particular systems, devices and methods described, as these may vary. The terminology used in the description is for the purpose of describing the particular versions or embodiments only and is not intended to limit the scope of the disclosure.

The following terms shall have, for the purposes of this application, the respective meanings set forth below. Unless otherwise defined, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a,” “an,” and “the” include plural references, unless the context clearly dictates otherwise. Thus, for example, reference to a “cell” is a reference to one or more cells and equivalents thereof known to those skilled in the art, and so forth.

As used herein, the term “about” means plus or minus 10% of the numerical value of the number with which it is being used. Therefore, about 50 mm means in the range of 45 mm to 55 mm.

As used herein, the term “consists of” or “consisting of” means that the device or method includes only the elements, steps, or ingredients specifically recited in the particular claimed embodiment or claim.

In embodiments or claims where the term “comprising” is used as the transition phrase, such embodiments can also be envisioned with replacement of the term “comprising” with the terms “consisting of” or “consisting essentially of.”

As will be understood by one skilled in the art, for any and all purposes, such as in terms of providing a written description, all ranges disclosed herein are intended as encompassing each intervening value between the upper and lower limit of that range and any other stated or intervening value in that stated range. All ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art, all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components as well as the range of values greater than or equal to 1 component and less than or equal to 3 components. Similarly, a group having 1-5 components refers to groups having 1, 2, 3, 4, or 5 components, as well as the range of values greater than or equal to 1 component and less than or equal to 5 components, and so forth.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

While the present disclosure has been illustrated by the description of exemplary embodiments thereof, and while the embodiments have been described in certain detail, the Applicant does not intend to restrict or in any way limit the scope of the appended claims to such detail. Additional advantages and modifications will readily appear to those skilled in the art. Therefore, the disclosure in its broader aspects is not limited to any of the specific details, representative devices and methods, and/or illustrative examples shown and described. Accordingly, departures may be made from such details without departing from the spirit or scope of the Applicant's general inventive concept.

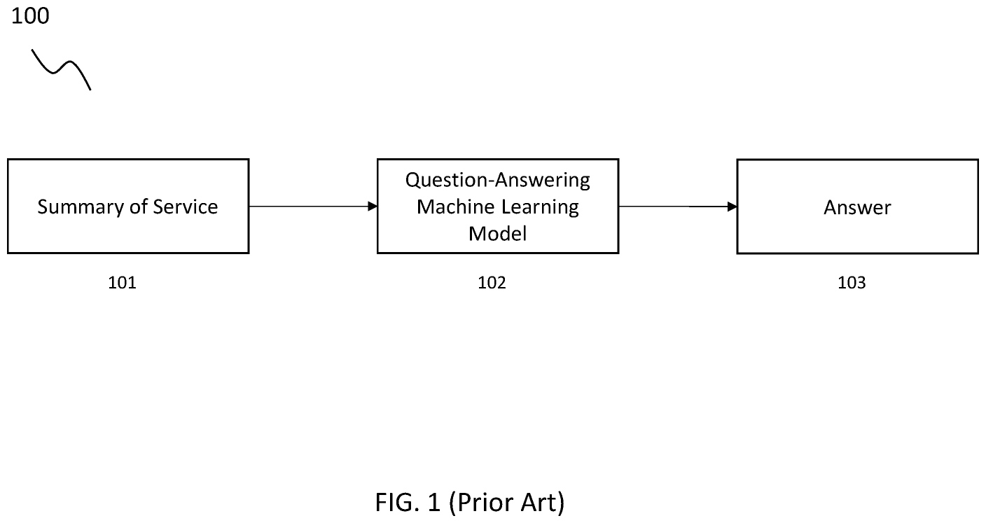

Deep learning models have been developed to answer questions based on information extracted from text corpora. Example machine learning algorithms include Bidirectional Encoder Representations from Transformers (BERT), a similar model trained specifically on biomedical data, BioBERT and Bidirectional Attention Flow (BiDAF). The algorithms are trained on a database. The information in the database may be filtered based on relevance to a specific topic. The algorithms may use natural language processing techniques to generate a vector space, comprising embeddings, to represent the language found in the text corpora. Referring to FIG. 1, the prior art usage of these models 100 is depicted. Traditionally, a document, such as a summary of service 101, along with a question is input into the question-answering machine learning model 102 to automatically produce an answer 103. In many instances, a summary of service 101 may include multiple segments of information which are irrelevant to the question. As a result, the error rate in the answer output 103 can be significant. Moreover, the model 102 is typically required to analyze the entirety of a summary of service 101, which can be computationally intensive.

As an example, a health insurer may have questions regarding the type of care provided in an episode of medical care to evaluate whether the patient has coverage. A summary of service 101 may include managerial information such as patient information, historical information, or provider information that is unrelated to the question.

As another example, a life insurer may have questions regarding the history of the client. In another example, a car insurer may have questions regarding the make and model of the vehicle as well as its use.

A system and method are needed for automatically segmenting a summary of service 101 prior to applying the question-answering machine learning model. The segment contains information relevant to answering the question. The question-answering machine learning model may only need to model the smaller segment, thereby lowering the computational requirements of the question-answering machine learning model and potentially improving the error rate.

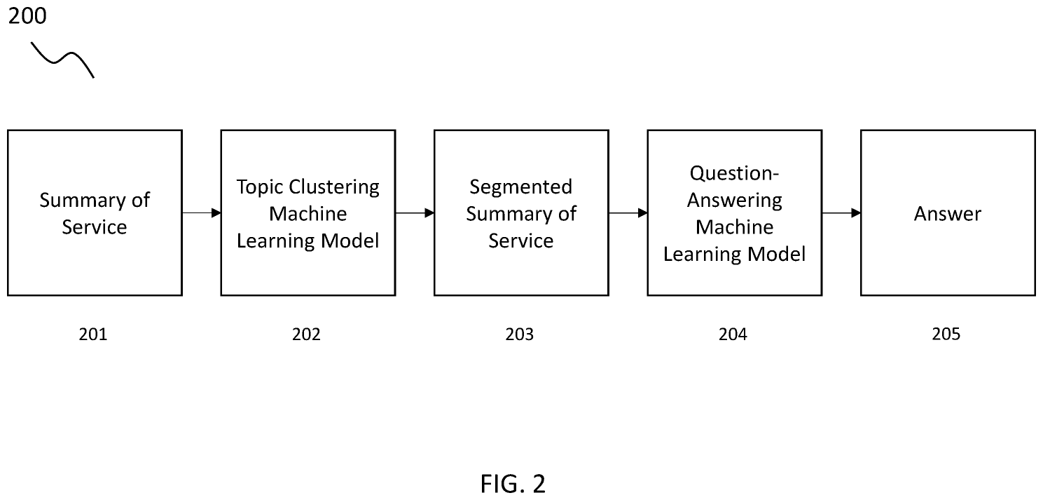

Referring to FIG. 2, an illustrative block diagram of a modified implementation of a question-answering machine learning model 200 is depicted in accordance with an embodiment. The modified implementation 200 may receive similar input in the form of a document, such as a summary of service 201. In some embodiments, the document may require preprocessing, such as optical character recognition (OCR), to format the document.

In certain embodiments, the summary of service 201 is segmented. In some embodiments, segmentation may include an analysis of structured fields within a summary of service 201. For example, the summary of service 201 may be provided in the Portable Document Format (PDF) with data fields or in the Extensible Markup Language (XML). In other embodiments, the summary of service 201 may be unstructured. For example, many insurance transactions include documentation that is scanned and/or faxed.

In some embodiments, segmenting the summary of service 201 may include analyzing one or more attributes of the text. In further embodiments, the attributes may include the font size, font type, or font style (e.g., bold, italic, and/or underlined).

In some embodiments, segmenting the summary of service 201 may include analyzing the summary of service 201 using a machine learning algorithm. In some embodiments, the machine learning algorithm may be a natural language processor. In further embodiments, the natural language processor may be a topic-clustering machine learning model 202. In some embodiments, the topic-clustering machine learning model 202 may generate embeddings to represent the language in a vector space. In further embodiments, the embeddings may be generated using the Continuous Bag-of-Words (CBOW) model and/or the Skip-Gram model. In some embodiments, the topic-clustering machine learning model 202 may include Latent Dirichlet allocation (LDA). For example, the topic-cluster machine learning model 202 may be Doc2Vec.

In certain embodiments, the topic-clustering machine learning model 202 may segment the summary of service 201 to generate a segmented summary of service 203. In some embodiments, the segmentation is performed by paragraph, heading, data field, and/or any other division found within the summary of service 201. In some embodiments, the topic-cluster machine learning model 202 identifies each segment with a topic. In some embodiments, in response to identifying a segment with a heading, the heading is associated as or as part of the topic.

In certain embodiments, a predetermined set of segment topics may be provided. In further embodiments, the topic-clustering machine learning model 202 may be trained to associate a closest-matching topic from the predetermined set to a segment. In other embodiments, the identified topic may be compared to the predetermined set of topics to determine a closest predetermined topic. In some embodiments, comparing the identified topic and the predetermined set may include natural language processing techniques. As an example, Word2Vec may be used to compare the identified and predetermined topics in an embedding space. In some embodiments, a threshold distance between two topics may be defined to determine whether such topics are relevant. In further embodiments, the distance may be calculated as a cosine similarity.

In certain embodiments, at least one of the identified segments in the segmented summary of service 203 is categorized as relevant to the question based on the identified topic. In some embodiments, at least one of the identified segments in the segmented summary of service 203 is categorized as irrelevant to the question based on the identified topic. In some embodiments, categorizing the relevance of a topic comprises receiving relevant predetermined topics associated with the question. In other embodiments, the question may also be analyzed by the topic-cluster machine learning algorithm 202 to determine a question topic. In some embodiments, the determined question topic may be compared to the predetermined and/or identified topics for each segment to determine one or more relevant segments. In some embodiments, comparing the question topic and the predetermined and/or identified topics may include natural language processing techniques. For example, Word2Vec may be used to compare the question topic and the predetermined and/or identified topics in an embedding space. In some embodiments, a distance between two topics may be compared with a threshold distance to determine whether the topics are relevant. In further embodiments, the distance between two topics may be calculated by determining a cosine similarity.

In certain embodiments, at least one relevant segment from the segmented summary of service 203 and a received question are input into the question-answering machine learning algorithm 204 to generate an answer 205. In some embodiments, the at least one relevant segment includes a plurality of segments. In some embodiments, the at least one relevant segment includes all segments not categorized as irrelevant.

In certain embodiments, one or more segments from a single segmented summary of service 203 may be utilized for generating the answer 205 to multiple questions. For example, an insurance provider may have multiple questions about a single service. A summary of the service may be segmented once, and either the same or a different subset of segments may be applied to answering each question.

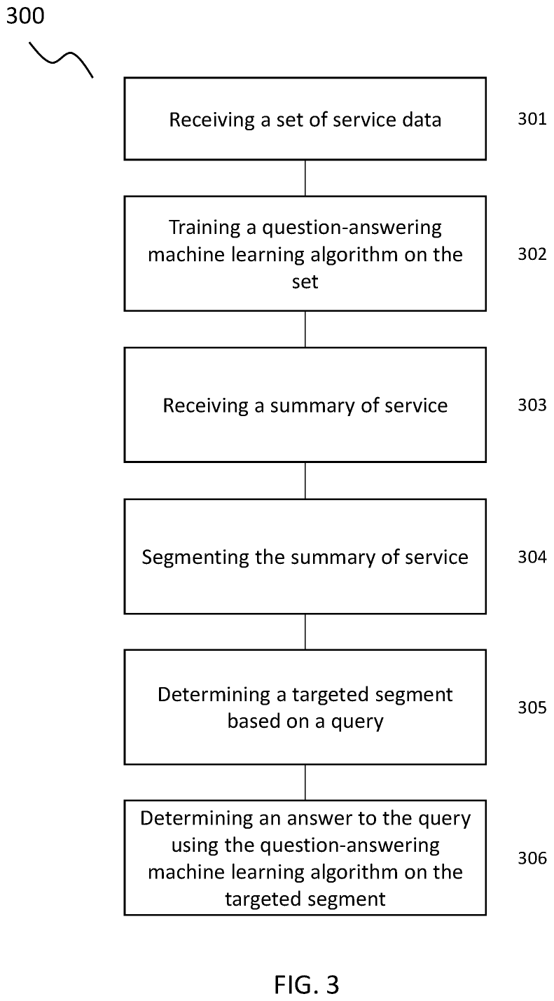

Referring to FIG. 3, an illustrative flow diagram of a method 300 for answering questions based on a summary of service is depicted in accordance with an embodiment. In certain embodiments, the method may include receiving 301 a dataset. In some embodiments, the dataset may be text-based. In further embodiments, the dataset my be specific to the service. As an example, the dataset may include insurance claims related to the service. In another example, wherein the service is medical care, the dataset may include any biomedical corpora (e.g., medical research, guidelines, procedure codes, etc.).

In certain embodiments, the method 300 may include training 302 a question-answering machine learning algorithm on the dataset. In some embodiments, the dataset may require preprocessing prior to training. Preprocessing may comprise transforming the dataset. In some embodiments, transformations may comprise filtering the dataset, adding identifiers to portions of the dataset, and/or formatting the structure of the dataset. In some embodiments, when training 302 a question-answering machine learning algorithm on the dataset, the algorithm may initially produce random results. In further embodiments, the algorithm may iteratively converge on a specific answer based on the provided input documentation.

In certain embodiments, the question-answering machine learning algorithm may include natural language processing. In further embodiments, the question-answering machine learning algorithm may include masked language modeling. Masked language modeling may train the algorithm to identify the context of words.

In certain embodiments, the method 300 may include receiving 303 a summary of service. In some embodiments, the summary of service may relate to an insurance claim (e.g., medical, life, auto, home, rental, disability, life settlement, or viatical settlement). In some embodiments, the summary of service may include information relating to the service provider (e.g., a doctor, clinic, mechanic, plumber, carpenter, etc.), information relating to the consumer for the service, details of the service, historical information associated with the service, and/or other relevant information. In further embodiments, the details of service may include a date, type of service, and/or pricing. In some embodiments, the type of service may be encoded based on an industry standard (e.g., procedure codes).

In certain embodiments, the method 300 may include segmenting 304 the summary of service. In some embodiments, segmenting 304 a summary of service may include performing a manual segmentation. In other embodiments, segmenting 304 a summary of service may include performing an automated segmentation. In further embodiments, performing an automated segmentation may include identifying one or more structured portions of a summary of service. In some embodiments, an automated segmentation may be performed using a topic-clustering machine learning algorithm trained to cluster the summary of service into segments sharing a similar topic. In further embodiments, automating the segmentation may include identifying a topic of each cluster.

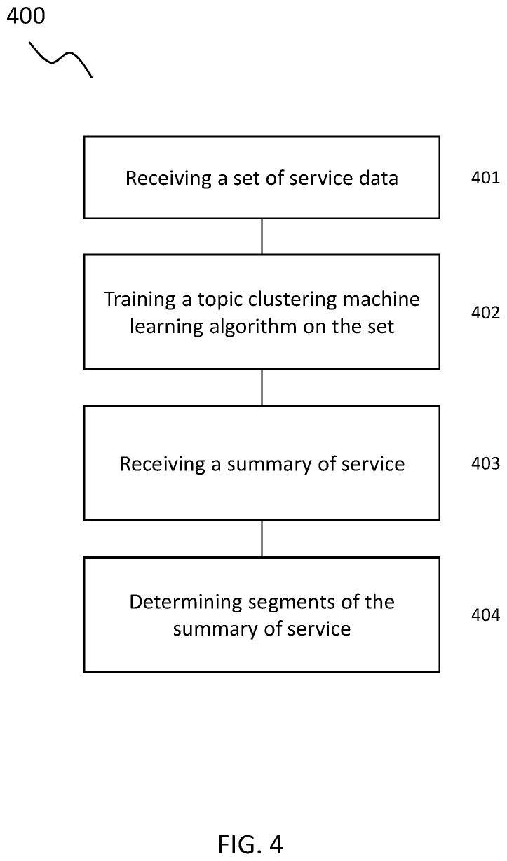

Referring to FIG. 4, an illustrative flow diagram of a method 400 for determining a segment of a summary of service is depicted in accordance with an embodiment. In some embodiments, the method 400 includes receiving 401 service data. In some embodiments, the service data may be received 401 from a database storing a plurality of documents. In other embodiments, the service data may include documentation relevant to the service. In further embodiments, the service data my include summaries of the service.

In certain embodiments, the method 400 may include training 402 a topic-clustering machine learning algorithm on the dataset. In some embodiments, the dataset may be preprocessed prior to training. Preprocessing may comprise transforming the dataset. In some embodiments, the dataset may be transformed by filtering the dataset, adding identifiers to portions of the dataset, and/or formatting the structure of the dataset. In some embodiments, a topic-clustering machine learning algorithm may initially produce random results when the algorithm is trained 402 on the dataset. In further embodiments, the algorithm may iteratively converge on a specific clustering and/or identified topics based on the dataset. In certain embodiments, the topic-clustering machine learning algorithm may perform natural language processing.

In certain embodiments, the method 400 may include receiving 403 a summary of service. In some embodiments, the summary of service may relate to an insurance claim (e.g., medical, life, auto, home, rental, disability, life settlement, orviatical settlement). In some embodiments, the summary of service may include information relating to the service provider (e.g., a doctor, clinic, mechanic, plumber, carpenter, etc.), information relating to the consumer for the service, details of the service, historical information associated with the service, and/or other relevant information. In further embodiments, the details of service may include a date, type of service, and/or pricing. In some embodiments, the type of service may be encoded based on an industry standard (e.g., procedure codes).

In certain embodiments, the method 400 may include determining 404 one or more segments of the summary of service. In some embodiments, the summary of service is analyzed using the trained topic-clustering machine learning algorithm. In further embodiments, the algorithm identifies clusters of information with a similar topic. In further embodiments, the algorithm identifies one or more topics for each cluster of information.

Referring back to FIG. 3, the method 300 may include determining 305 a targeted segment based on a query. In some embodiments, a topic associated with a question may be provided with the question. In some embodiments, the method 300 may include analyzing a query for a topic. In some embodiments, a topic-clustering machine learning algorithm may be used to analyze a topic query. A person of ordinary skill in the art will note that determining a query topic should require less computation than segmenting an entire document. In some embodiment, the query topic may be compared to topics of the one or more segments. In some embodiments, where topics are selected from a predetermined list, the comparison may be straightforward. In other embodiments, the topics may be compared as embeddings in a vector space. In further embodiments, topics may be compared using a similarity measure, such as cosine similarity. In some embodiments, one or more segments, with a similar topic to the query, may be identified.

In certain embodiments, a topic may be determined for only a portion of identified segments. For example, if a segment topic is determined which is similarly within a threshold of the query topic, processing the remaining segments may be omitted, thus saving processing time.

In certain embodiments, the method 300 may further include determining 306 an answer to the query using the question-answering machine learning algorithm on the one or more identified segments. Because the document is segmented, only a portion of the document may be processed by the question-answering machine learning algorithm. In some embodiments, the answer may be used for insurance preauthorization or processing.

### Example: Medical Preauthorization System

An example automated medical preauthorization system may require answering multiple questions related to a summary of medical care. A topic clustering machine learning algorithm may identify multiple segments within the summary of medical care including topics focused on patient information, patient history, physical examination information, home medicine information, pertinent results, management, and discharge planning. The system may ask to identify the patient. The closest topic, patient information, may be targeted. A question-answering machine learning algorithm may then analyze the patient information segment resulting in the determination of a patient name and/or member/group identification numbers. The system may ask for referral history. The closest topic, patient history, may be targeted. The question-answering machine learning algorithm may then analyze the patient history segment resulting in the determination of a referral status. Any number of questions may be similarly answered based on relevant identified segments.

### Example: Life Insurance Preauthorization System

An example automated life insurance preauthorization system may require answering multiple questions related to a summary of client history. A topic clustering machine learning algorithm may identify multiple segments within the summary of client history including topics focused on client information, client history, physical examination information, home medicine information, pertinent results, and management. The system may ask to identify the client. The closest topic, client information, may be targeted. A question-answering machine learning algorithm may then analyze the client information segment resulting in the determination of a client name and/or member/group identification numbers. The system may ask for the client's smoking habits. The closest topic, client history, may be targeted. The question-answering machine learning algorithm may then analyze the client history segment resulting in the determination of smoking habits. Any number of questions may be similarly answered based on relevant identified segments.

### Example: Car Insurance Preauthorization System

An example automated car insurance preauthorization system may require answering multiple questions related to a summary of repair. A topic clustering machine learning algorithm may identify multiple segments within the summary of repair including topics focused on client information, client history, vehicle history, required repairs, and management. The system may ask to identify the client. The closest topic, client information, may be targeted. A question-answering machine learning algorithm may then analyze the client information segment resulting in the determination of a client name and/or member/group identification numbers. The system may ask for the vehicle's estimated worth. The closest topic, vehicle history, may be targeted. The question-answering machine learning algorithm may then analyze the vehicle history segment resulting in the determination of vehicle's estimated worth. Any number of questions may be similarly answered based on relevant identified segments.

### Example Computer System

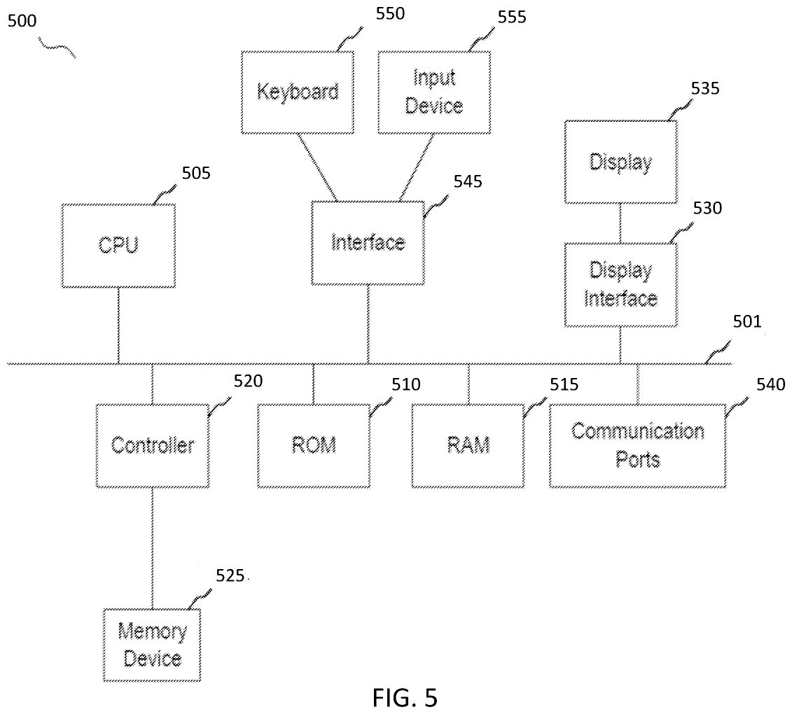

FIG. 5 depicts a block diagram of exemplary data processing system 500 comprising internal hardware that may be used to contain or implement the various computer processes and systems as discussed above. In some embodiments, the exemplary internal hardware may include or may be formed as part of a database control system. In some embodiments, the exemplary internal hardware may include or may be formed as part of an additive manufacturing control system, such as a three-dimensional printing system. A bus 501 serves as the main information highway interconnecting the other illustrated components of the hardware. CPU 505 is the central processing unit of the system, performing calculations and logic operations required to execute a program. CPU 505 is an exemplary processing device, computing device or processor as such terms are used within this disclosure. For example, CPU 505 may be representative of a graphics processing unit (GPU) in some systems. Read only memory (ROM) 510 and random access memory (RAM) 515 constitute exemplary memory devices.

A controller 520 interfaces with one or more optional memory devices 525 via the system bus 401. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, data, common files, or one or more databases for storing data.

Program instructions, software or interactive modules for performing any of the functional steps described above may be stored in the ROM 510 and/or the RAM 515. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 530 can permit information from the bus 501 to be displayed on the display 535 in audio, visual, graphic or alphanumeric format. Communication with external devices can occur using various communication ports 540. An exemplary communication port 540 can be attached to a communications network, such as the Internet or a local area network.

The hardware can also include an interface 545 which allows for receipt of data from input devices such as a keyboard 550 or other input device 555 such as a mouse, a joystick, a touch screen, a remote control, a pointing device, a video input device and/or an audio input device.

At least a portion of the data processing system 500 can be decentralized and/or cloud-based.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Instead, this application is intended to cover any variations, uses, or adaptations of the present teachings and use its general principles. Further, this application is intended to cover such departures from the present disclosure as come within known or customary practice in the art to which these teachings pertain. Many modifications and variations can be made to the particular embodiments described without departing from the spirit and scope of the present disclosure as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of extracting information from a summary of service, the method comprising:
receiving a summary of service and a query related to the summary of service;
segmenting the summary of service into one or more data categories to create a structured summary of service;
determining a targeted segment of the structured summary of service based on the query; and
determining an answer to the query using a question-answering machine learning model and the targeted segment.

2. The method of claim 1, further comprising:
receiving service data; and
training the question-answering machine learning model using the service data.

3. The method of claim 1, wherein segmenting the summary of service into one or more data categories comprises:
generating the structured summary of service using a topic-clustering machine learning model.

4. The method of claim 3, wherein segmenting the summary of service into one or more data categories further comprises:
receiving one or more summaries of service;
transforming the one or more summaries of service into a training set using contextual information; and
training the topic-clustering machine learning model using the training set.

5. The method of claim 3, wherein the topic-clustering machine learning model is a natural language processor.

6. The method of claim 3, wherein the topic-clustering machine learning model is a Doc2Vec model.

7. The method of claim 1, wherein the question-answering machine learning model is a natural language processor.

8. The method of claim 1, wherein the question-answering machine learning model is a Bidirectional Encoder Representations from Transformers (BERT) model.

9. The method of claim 1, wherein the service comprises at least one of: a medical diagnosis, a car repair estimate, a home repair estimate, or a life insurance summary.

10. The method of claim 1, wherein the service comprises a medical diagnosis and wherein the targeted segment comprises at least one of patient information, patient history, physical examination, home medicine, pertinent results, management, and discharge planning.

11. The method of claim 1, wherein determining a targeted segment of the structured summary of service based on the query comprises comparing a topic of each segment in the structured summary of service with a topic associated with the query.

12. The method of claim 11, further comprising generating the topic associated with the query by using a topic-clustering machine learning model on the query.

13. A system for extracting information from a summary of service, the system comprising:
one or more processors; and
one or more non-transitory, processor-readable storage medium, wherein the one or more non-transitory, processor-readable storage medium comprises one or more programming instructions that, when executed, cause the one or more processors to:
receive service data;
train a question-answering machine learning model using the service data;
receive a summary of service and a query related to the summary of service;
segment the summary of service into one or more data categories to create a structured summary of service;
determine a targeted segment of the structured summary of service based on the query; and
determine an answer to the query using the question-answering machine learning model and the targeted segment.

14. The system of claim 13, wherein the one or more programming instructions that, when executed, cause the one or more processors to segment the summary of service into one or more data categories further comprises one or more programming instructions that, when executed, cause the one or more processors to:
receive one or more testing summaries of service;
transform the one or more testing summaries of services into a training set using contextual information;
train a topic-clustering machine learning model using the training set; and
generate the structured summary of service using the topic-clustering machine learning model.

15. The system of claim 14, wherein the topic-clustering machine learning model is a natural language processor.

16. The system of claim 13, wherein the question-answering machine learning model is a natural language processor.

17. The system of claim 13, wherein the service comprises at least one of: a medical diagnosis, a car repair estimate, a home repair estimate, or a life insurance summary.

18. The system of claim 13, wherein the service comprises a medical diagnosis and wherein the targeted segment comprises at least one of patient information, patient history, physical examination, home medicine, pertinent results, management, and discharge planning.

19. The system of claim 13, wherein the one or more programming instructions that, when executed, cause the one or more processors to determine a targeted segment of the structured summary of service based on the query further comprises one or more programming instructions that, when executed, cause the one or more processors to:
compare a topic of each segment in the structured summary of service with a topic associated with the query.

20. The system of claim 19, further comprising one or more programming instructions that, when executed, cause the one or more processors to:
generate the topic associated with the query by using a topic-clustering machine learning model on the query.
